(19) United States
(12) Patent Application Publication
(10) Pub. No.: US 2002/0043081 A1
(43) Pub. Date: Apr. 18, 2002

(54) Eliminating springback in EUV lithography mirrors

(76) Inventors: Bradley F. Bowden, Painted Post, NY (US); Claude L. Davis JR., Painted Post, NY (US); Kenneth E. Hrdina, Horseheads, NY (US); Gautam Meda, Corning, NY (US)

Correspondence Address: CORNING INCORPORATED, SP-TI-3-1, CORNING, NY, 14831

(21) Appl. No.: 09/943,445

(22) Filed: Aug. 30, 2001

Related U.S. Application Data
(60) Provisional application No. 60/240,007, filed on Oct. 13, 2000.

(51) Int. Cl. C03C 19/00

(52) U.S. Cl. 65/61; 65/29.11

(57) ABSTRACT

A method for manufacturing an extreme ultraviolet lithography mirror for use in includes machining a bottom face of a mirror blank, polishing a top face of the mirror blank to produce a polished mirror, and cutting a piece from the polished mirror. Another method for manufacturing an extreme ultraviolet lithography mirror for use in includes annealing a faceplate to a honeycomb core, polishing the faceplate to produce a polished mirror, and cutting a piece from the polished mirror.

### RELATED APPLICATION

This Application claims priority of provisional U.S. Application Serial No. 60/240,007, filed on Oct. 13, 2000, and entitled “Eliminating Springback in EUV Mirrors.”

### FIELD OF THE INVENTION

The present invention relates to extreme ultraviolet (EUV) mirrors for EUV lithography. More particularly, it relates to methods for manufacturing EUV mirrors.

### BACKGROUND OF THE INVENTION

Extreme ultraviolet (EUV) lithography (EUVL) is a relatively new form of lithography. EUVL uses extreme ultraviolet (EUV, also called soft X-ray) radiation with a wavelength in the range of 10 to 14 nanometers (nm) to perform the imaging. Up to now, optical lithography has been the lithographic technique of choice in the high-volume manufacture of integrated circuits (IC). The constant improvement in optical lithography has allowed it to remain the semiconductor industry's workhorse through the 100 nm or smaller generation of devices. However, to pack even higher density circuits into IC chips, new technologies (Next-Generation Lithographies, NGL) will be required. EUVL is one NGL technology vying to become the successor to optical lithography.

In many respects, EUVL is similar to the optical lithography. For example, as illustrated in FIG. 1, the basic optical design for an EUVL system is similar to that of an optical lithographic system. It comprises a light source 1, a condenser 2, a mask (reticle) 4 on a mask stage 5, an optical system 6, and a wafer 7 on a wafer stage 8. Both EUV and optical lithographies use optical systems (cameras) to project images on the masks onto substrates which comprise silicon wafers coated with photo resists. However, the apparent similarity stops here. Because EUV is strongly absorbed by virtually all materials, EUV imaging must be performed in vacuum, which is achieved by enclosing the system in a chamber 3. In addition, the chamber 3 might be further partitioned into different compartments 10 and 20, which have their own vacuum systems. Because EUV is absorbed by most materials, there is no suitable lenses to focus and project an image on mask 4 onto a substrate (wafer) 7. As a result, it is necessary to operate EUVL in a reflective mode instead of a transmissive mode. In the reflective mode, light is reflected from mirrors (not shown; inside the optical system 6), instead of being transmitted through lenses. Even with reflective optics, there are not many materials capable of reflecting EUV. In order to achieve reasonable reflectivities at near normal incidence (i.e., an incident beam landing on the surface of a mirror at an angle close to normal to the surface), the surface of a mirror must be coated with multilayer, thin-film coatings. These multilayer, thin-film coatings reflect EUV in a phenomenon known as distributed Bragg reflection.

The multilayer coatings for the reflective surfaces in EUVL imaging systems consist of a large number of alternating layers of materials having dissimilar EUV optical constants. These multilayers provide a resonant reflectivity when the period of the layers is approximately λ/2, where λ is the wavelength. The most promising EUV multilayers are coatings of alternating layers of molibdium (Mo) and silicon (Si). These layers are deposited with magnetron sputtering. Each layer of Mo or Si is coated to a thickness of λ/4 of the EUV light so that it will have a periodicity of λ/2. In this type of reflectors, a small portion of the incident light is reflected from each silicon surface. The thickness of the layers causes the reflected light waves to interfere constructively. The more layers there are, the more light will be reflected. However, imperfections in surface coating will eventually diminish the reflectivity return of more coatings. Currently, most mirrors in EUVL systems have around 40 alternating layer pairs of Mo:Si. Furthermore, most of these Mo:Si multilayers are optimized to function best with wavelengths at around 13.4 nm, which is the wavelength of a typical laser plasma light source.

A typical EUVL optical system or camera (see 6 in FIG. 1) consists of several mirrors (e.g., a four-mirror ring-field camera shown in FIG. 2). The mirrors that comprise the camera must have a high degree of perfection in surface figure and surface finish in order to achieve diffraction limited imaging. It is predicted that the surface figure (basic shape) of each mirror must be accurate to 0.25 nm rms (root mean square) deviation, or better. In addition to surface figure, stringent requirements must also be placed on the finish of the surfaces. The challenge for a fabricator of optics for EUVL is to achieve the desired levels of surface figure accuracy and surface finish simultaneously. In addition, because mirrors have fewer degrees of freedom than do lenses, most mirrors in an EUVL camera will have aspherical surfaces. The aspherical surfaces pose further challenges in the manufacturing of EUV mirrors.

FIG. 2 illustrates a typical prior art four-mirror optical system for EUVL applications. Such an optical system is used to project and reduce an image on a mask onto a wafer. The reduction achieved by the optical system permits the printing of a image smaller than that on the mask onto a wafer. The projection operation is typically carried out in a step-and-scan process. In a step-and-scan operation, a light beam from a light source (see 1 and 2 in FIG. 1) is used to scan the image on the mask. The light beam L reflected from the mask is further reflected by four mirrors M1, M2, M3 and M4 in succession to project and reduce the image from the mask onto the wafer. Due to the arrangement of these mirrors, the light path will be blocked by portions of the mirrors (see the shapes shown in dotted lines in FIG. 2). Some parts of the mirrors would have to be removed to avoid this blockage. One way to accomplish this is to cut out small notches in some of these mirrors so that the light can go through. Alternatively, one may cut the useable portions from the finished mirrors and arrange them in a non-coaxial fashion as shown in FIG. 2. Among the four mirrors shown in FIG. 2, only M3 is spherical, whereas the other three mirrors M1, M2, and M4 are aspherical-they are parts of spherical mirrors. With either approach, some mirrors to be used in an EUVL system would have to be cut from the finished spherical mirrors. Although the problem is shown in FIG. 2 using a four-mirror EUVL optical system, similar problems are encountered in other systems, e.g., a three-mirror or six mirror system.

FIGS. 3A, 3B, and 3C illustrate a common method of making aspherical mirrors. First, a spherical mirror blank 31 is prepared and polished (see FIG. 3A). Then, the desired piece 33 is cut out from the finished mirror 32 (see FIG. 3B). However, after the cutout piece is removed, the remaining piece 34 (or the cutout piece 33) typically will experience slight distortion from its originally completed shape due to the “springback” effect, which results from relief of stress existing in the original mirror (see FIG. 3C). Although the deformation resulting from springback is typically minute, it nevertheless is detrimental for EUV mirrors because EUV mirrors need to have substantially perfect surface figures and surface finishes.

The springback problem may be avoided if the cutout is removed prior to finishing the mirror. Methods are known in the art for shaping and polishing aspherical mirrors. For example, U.S. Pat. No. 5,214,685 issued to Howells discloses a method for polishing an aspherical mirror. However, the stringent requirement for an EUV mirror makes it extremely difficult to achieve the final finish required for a perfect mirror starting from such a cutout piece due to problems encountered in polishing over the edges.

Therefore, it is desirable to have methods that significantly reduce the springback problem in manufacturing the EUV mirrors.

### SUMMARY OF INVENTION

Embodiments of the invention relate to methods for manufacturing mirrors for use in EUV lithography. Some embodiments include machining a bottom face of a mirror blank, polishing a top face of the mirror blank to produce a polished mirror, and cutting a piece from the polished mirror.

Other embodiments include annealing a faceplate to an included void structure core, polishing the faceplate to produce a polished mirror, and cutting a piece from the polished mirror. The faceplate and the core may have a predetermined configuration approximating the final configuration of the mirror.

### BRIEF DESCRIPTION OF DRAWINGS

FIG. 1 is a diagram of a prior art EUVL system.

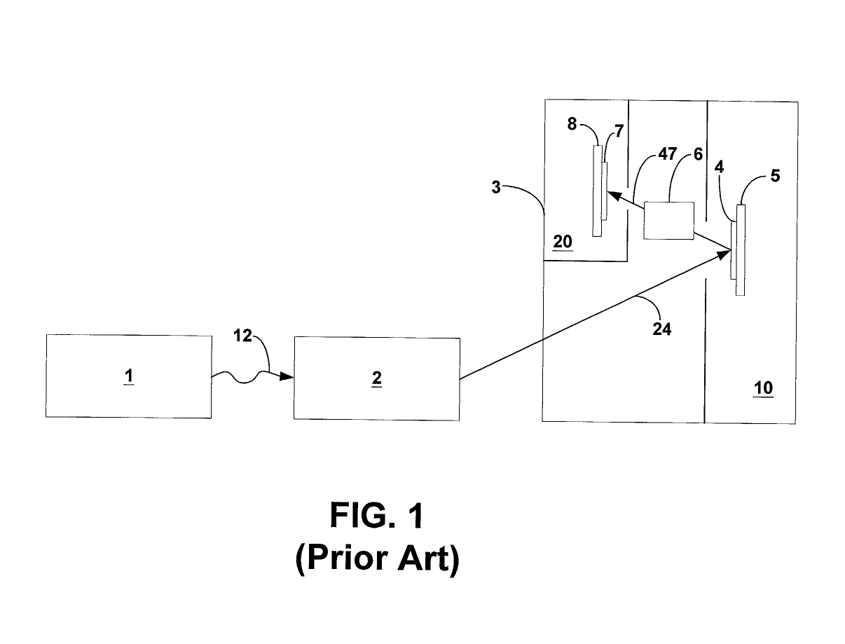

FIG. 2 is a diagram illustrating a prior art four-mirror optic system for an EUVL camera.

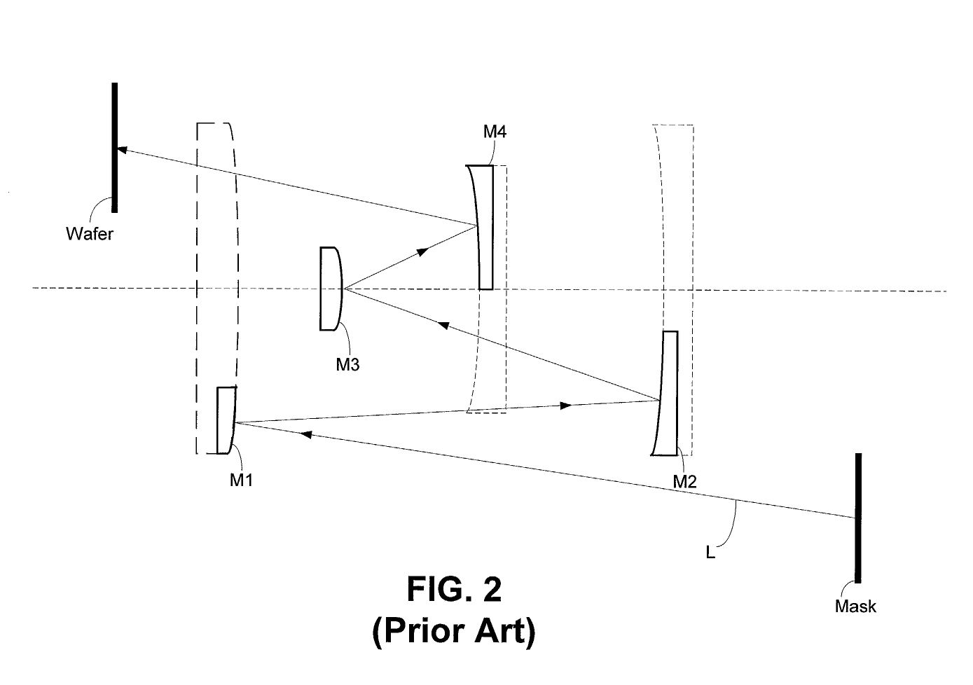

FIGS. 3A, 3B, and 3C are diagrams illustrating methods for manufacturing an aspherical EUV mirror. FIG. 3A shows an oblique view of a polished mirror. FIG. 3B illustrates a top view of a polished mirror with a cutout piece marked. FIG. 3C shows an oblique view of the remaining piece after the cutout is removed.

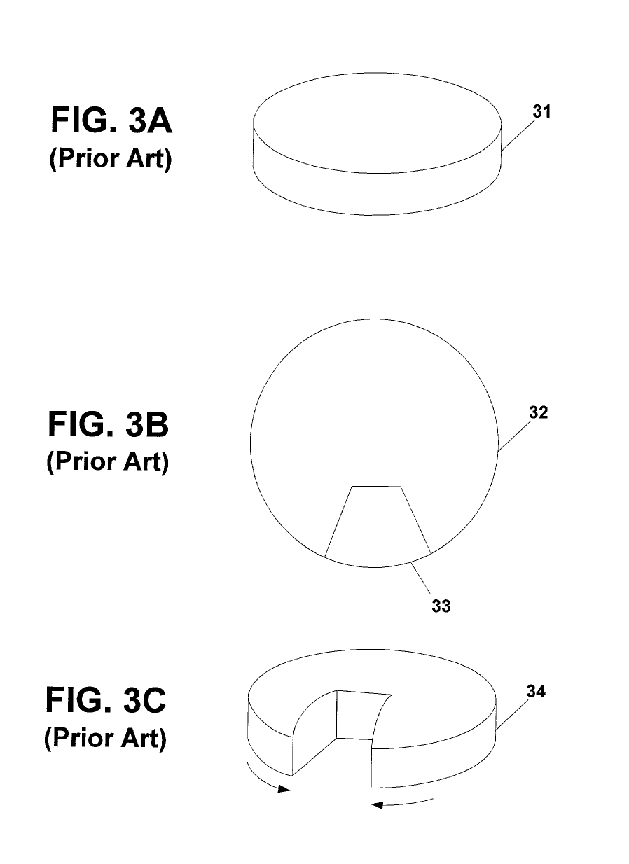

FIGS. 4A, 4B, and 4C are diagrams illustrating a method for manufacturing an aspherical EUV mirror according to one embodiment of the invention. FIG. 4A shows an oblique view of a finished mirror. FIG. 4B shows a bottom view with the cutout piece marked. FIG. 4C shows an oblique view of the remaining piece after the cutout is removed.

FIGS. 5A, 5B, and 5C are diagrams illustrating a method for manufacturing an aspherical EUV mirror according to another embodiment of the invention. FIG. 5A shows a faceplate and a honeycomb core. FIG. 5B shows a finished mirror. FIG. 5C shows another finished mirror.

### DETAILED DESCRIPTION

Embodiments of the invention relate to methods for manufacturing EUV mirrors. The embodiments significantly reduce the springback effect by reducing the mass of the blank before finishing. When the mass of a mirror is reduced, internal stress will be reduced. Consequently, the springback is reduced when a piece is removed from the final, finished mirror.

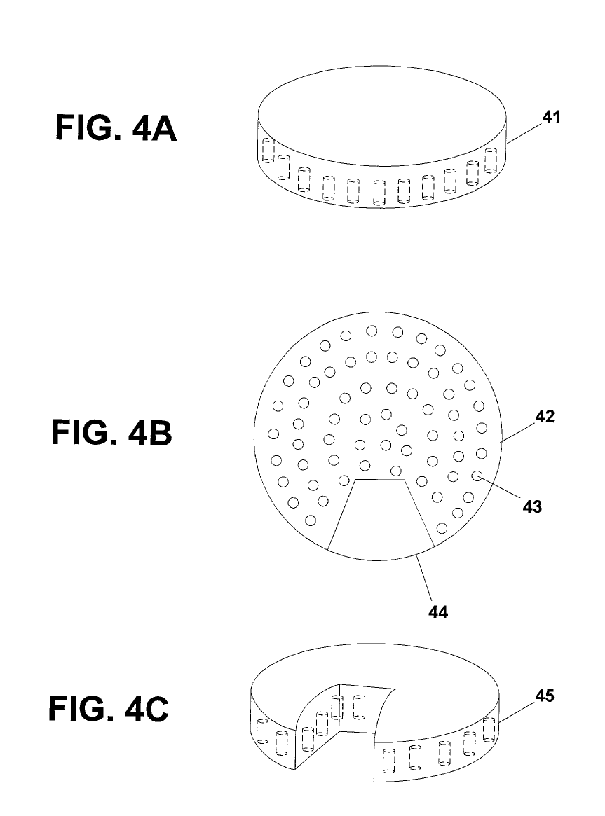

FIGS. 4A-4C illustrate some of such embodiments. In FIG. 4A, a mirror blank 41 is first machined to remove the bulk of the mass from the back face of the mirror blank. Machining to reduce mass includes making holes or similar voids in the mirror blank 41. The machining is performed in such a manner that the holes thus created stop at a selected distance from the top face of the mirror blank 41. This leaves a reasonable thickness of blank material under the top face, which can then be polished to produce the finished mirror face. The sizes, shapes and numbers of the holes created by machining are not critical. There may be more small holes or few big holes: Generally machining seeks to reduce the mass of the mirror and to create some voids in the mirror component so that they have less internal stress, hence less springback when a cut out piece is removed. The machining could be achieved by any method known in the art suitable for such purposes. These methods may include those used in the manufacturing of conventional light weight mirror, such as conventional CNC (computer numerical control) machining, fusion core structure, and abrasive waterjet technology. Alternatively, a mirror blank may have such holes or equivalents pre-fabricated, i.e., the mirror blank has voids (holes) on the back side, for example, by preparing the mirror blanks using a suitable mold. With any of these approaches, the bulk of the body stresses are removed and the faceplate (top face) of the mirror can be finish polished after the bulk material is removed. FIG. 4B shows a bottom view of the mirror with an intended cutout piece indicated by numeral 44. The mirror 42 has many holes 43, which are generated by any of the above-mentioned “machining” process. Although this embodiment shows that the cutout piece 44 has no holes, it is equally applicable that the cutout piece 44 might also have holes to further reduce the mass of the mirror before the cutout piece 44 is removed. FIG. 4C illustrates the remaining piece 45 of the mirror after the cutout piece 44 is removed. There will be less springback (hence less deformation) in both the remaining piece 45 and the cutout piece 44. This is because the reduced mass in these pieces will have less internal stress. Furthermore, the holes or voids in these pieces should render these pieces more accommodating of any residual stress.

The mirror blank 41 may be lapped or polished by any method known in the art. When the mirror has been polished to the desired figure and finish, coating of molibdium (Mo) and silicon (Si) can be accomplished with either magnetron sputtering, ion-beam sputtering, or other suitable methods. In a typical EUVL application, these mirrors should be coated with multiple alternating layers of Mo and Si. Polishing as used herein may include the Mo:Si coating step. Once the mirror is polished, the desired piece may be cut out with methods known in the art. Other embodiments of the invention use “honeycomb extrusion” technology methods to create the mirror blank. Various included void structures, called cellular bodies, with different geometries have been extruded to produce very light weight structures. A typical structure may have an effective density of 50% to 98% less than that of an equivalent solid material. These cellular bodies have the additional property of having very low thermal expansion coefficient throughout the body due to homogenizing effect of the extrusion process. Several methods are available for the formation of included void structures, which may have cells in hexagon, square, triangle or other shapes. The cell shapes refer to the shapes of cellular structures in the cross section of a honeycomb structure. The methods for honeycomb formation include, for example, extrusion, casting, and fusion methods.

In an extrusion method, a starting material in the form of a paste (which is made from a powder starting material mixed with a suitable additive to make it plastic and flexible) is forced through a die (having a desired cellular structure) to produce a “green” honeycomb, which is then fired at high temperature to produce a “mature” honeycomb. For example, U.S. Pat. No. 5,884,138 issued to Chalasani, et al. discloses a method of extrusion suitable for this purpose.

In a casting method, a slurry of a starting material (e.g., titanium silicate glass) is poured into a mold. The structure thus formed is fired at high temperature to densify the structure and produce the final honeycomb structure. In a fusion method, pieces (e.g., strips) of suitable materials (e.g., glass, glass-ceramic, or composite material) are fused with thermal treatment to form the cellular structures in a honeycomb. Particular shapes of cells in a honeycomb are not important for the invention. These shapes may include triangular, square, rectangular, hexagonal, or other polygonal shapes. Furthermore, the shapes of the cells need not be uniform, and a honeycomb may include a combination of different cellular structures.

Some embodiments of the invention relate to methods for manufacturing light-weight EUV mirrors using included void structure materials. The methods include formation of an included void core, annealing a faceplate to the core, and shaping and polishing the faceplate to produce an EUV mirror. After the formation of a honeycomb structure, the piece may be shaped into an EUV mirror. The shaping processes may include machining the core. Several machining processes are known in the art and are applicable to the invention. For example, U.S. Pat. No. 5,487,694 issued to Deming discloses a method for shaping honeycomb substrates. U.S. Pat. No. 6,176,588 B1 issued to Davis et al. discloses low cost light weight mirror blanks based on honeycomb structures. These honeycomb bodies may be formed in the shape of the mirrors and the face plates attached to these bodies using fusion or frit fusion processes, for example.

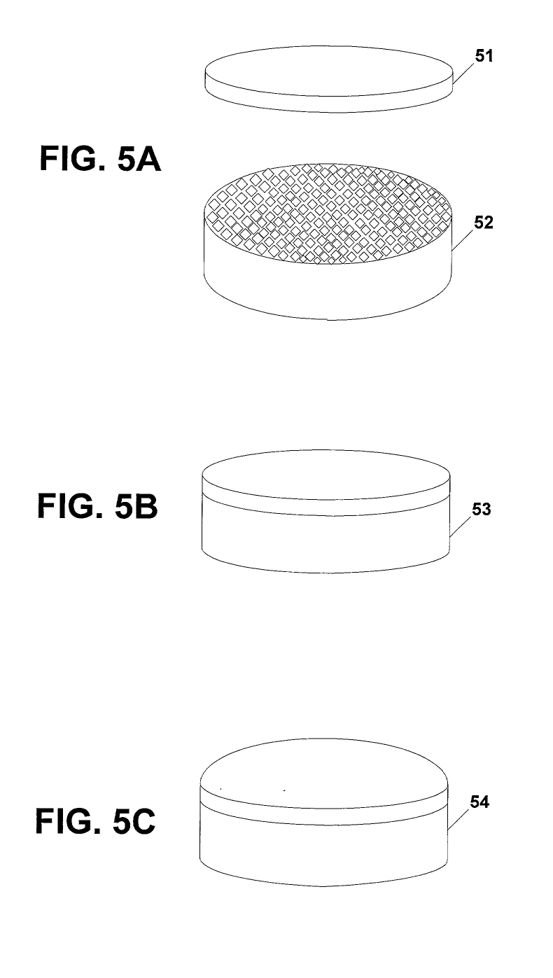

FIGS. 5A-5C illustrate some methods according to such embodiments. FIG. 5A illustrates a faceplate 51 and an included void structure core 52, which can be annealed together by methods known in the art to produce a mirror blank. The faceplate 51 may be made from any material that is capable of being polished to the required optical finish. Such materials include glass, glass ceramics, and metals. However, it is desirable for the faceplate 51 to utilize a glass or a glass ceramic having a coefficient of thermal expansion (CTE) that is closely equivalent or identical to that of the core 52.

After annealing, the mirror blank is shaped and polished to produce the desired mirror 53 as shown in FIG. 5B. A piece from the polished mirror may then be cutout to produce an aspherical mirror (not shown). In another embodiment, a faceplate 51 and a honeycomb core 52 may be pre-shaped to a near final configuration before they are annealed to produce a mirror blank 54 (see FIG. 5C), which has a necessary shape for a final mirror. In other words, the faceplate 51 and the core 52 may have a predetermined configuration that is near the final configuration of the mirror. In these embodiments, the faceplate 51 may be thermally sagged to near a shape that matches the shape on the core 52. Thus, less material needs to be removed from the faceplate 51 during polishing. As shown in FIG. 5C, mirror blank 54, having a near final configuration, would require little or no shaping before the faceplate (51 in FIG. 5A) is polished. Furthermore, in these embodiments, the materials for the core and the faceplates may be matched so that the core and the face plate will have similar thermal expansion coefficients (CTE). This will alleviate any thermal stress related problems. Again, a cutout (not shown) may be removed from the final polished mirror to provide an aspherical mirror.

Several methods known in the art are suitable for annealing a faceplate 51 to a honeycomb core 52. These include thermal fusion, frit fusion, and annealing using an adhesive (i.e., adhesion). With thermal fusion, the faceplate 51 and the honeycomb core 52 are fused (joined) by applying thermal energy to melt the regions at the joint. In frit fusion, low-melting frits (powders) of a glass material are added to the joint to “glue” the pieces together when heated. For example, U.S. Pat. No. 6,048,811 issued to Morena discloses a frit fusion process suitable for this process. Similarly, the annealing may be achieve by adhesion, i.e., by applying suitable adhesive materials at the joint. Suitable adhesive materials include, but not limited to, epoxies, RTV (room temperature vulcanizing) silicone adhesives, and solder or bonding materials which, upon heating, will melt and form a bond between the core and the faceplate. When the faceplate is constructed of a material having a CTE closely equivalent or identical to that of the core, the adhesive should ideally match the CTE.

The material for EUV mirrors may be a light-weight glass or glass-ceramic material. Furthermore, to afford better thermal management, these materials are preferably of very low thermal expansion coefficient. Such light-weight, low thermal expansion materials may include high-purity fused silica (such as the HPFS® glass from Corning, Inc.) and ultra low expansion glass (such as the ULE® glass from Corning, Inc.). The HPFS® glass from Corning, Inc. is a high purity synthetic amorphous silicon dioxide glass manufactured by flame hydrolysis. It has a very low CTE and excellent optical qualities. The ULE® glass from Corning, Inc. is a titanium silicate glass containing between about 6 to 8 wt. % TiO₂, with a preferred content of about 7 wt. % TiO₂. It has a CTE of zero at room temperature.

While the invention has been described using a limited number of embodiments, those skilled in the art, having the benefit of this disclosure, will appreciate that other variations are possible without departing from the scope of the invention as disclosed herein. Accordingly, the scope of the invention should be limited only by the attached claims.

What is claimed is:

1] A method for manufacturing an extreme ultraviolet lithography mirror for use in, comprising:
machining a bottom face of a mirror blank so as to reduce a mass thereof while substantially maintaining an external shape thereof; and
polishing a top face of the mirror blank to produce a polished extreme ultraviolet lithography mirror.

2] The method of claim 1, further comprising removing a light-path cutout from the polished extreme ultraviolet lithography mirror.

3] The method of claim 1, wherein the machining is accomplished by one selected from computer numerical control machining, abrasive waterjet technology, and fusion core structure technology.

4] The method of claim 1, wherein said machining comprises producing a plurality of holes in said bottom face, wherein said holes have a depth selected to enable forming a top surface in the mirror blank to a selected figure.

5] A method for manufacturing an extreme ultraviolet lithography mirror comprising:
providing a mirror blank having voids on at least a back side,
polishing a top face of said mirror blank having said voids to produce a polished extreme ultraviolet lithography mirror.

6] The method of claim 5, further comprising removing a light-path cutout from the polished mirror.

7] A method for manufacturing an extreme ultraviolet lithography mirror comprising:
annealing a faceplate to a core having included void structures therein; and
polishing the faceplate to produce a polished extreme ultraviolet lithography mirror.

8] The method of claim 7, further comprising removing a light path cutout from the polished mirror.

9] The method of claim 7, wherein the annealing is accomplished by one selected from fusion, frit fusion, and adhesion.

10] The method of claim 7, wherein the faceplate and the core have substantially the same coefficient of thermal expansion.

11] The method of claim 7, wherein the faceplate and the core have a predetermined configuration near a configuration of the extreme ultraviolet lithography mirror.

12] The method of claim 7, said method including extrusion forming said core.

13] The method of claim 7, said method including mold-forming said core.
